(19) United States
(12) Patent Application Publication
(10) Pub. No.: US 2014/0328052 A1
(43) Pub. Date: Nov. 6, 2014

(54) LIGHT-EMITTING ASSEMBLY AND LIGHT-EMITTING FLOOR SYSTEM CONTAINING THE SAME

(71) Applicant: Revolution Display, Glendale, CA (US)

(72) Inventors: JEREMY HOCHMAN, GLENDALE, CA (US); MATS KARLSSON, KORTRIJK (BE)

(21) Appl. No.: 13/907,146

(22) Filed: May 31, 2013

Related U.S. Application Data
(60) Provisional application No. 61/654,538, filed on Jun. 1, 2012.

(51) Int. Cl. F21V 21/02; F21V 8/00; F21V 21/03

(52) U.S. Cl. CPC F21V 21/02; F21V 21/03; F21K 9/52; G02B 6/0001
USPC 362/147; 362/153; 362/231; 362/235

(57) ABSTRACT

Disclosed is a light-emitting assembly containing a panel having a first side and an opposing second side, a plurality of bores extending from the first side to the second side, an LED light source, such as a printed circuit board, having first side and an opposing second side, the first side of the LED light source adjacent to the side of the panel, the LED light source comprising a plurality of LEDs and a plurality of optical wave guides, each wave guide having a first end and a second end, the first end disposed in one of the bores and the second end optically connected to one of the LEDs.

### RELATED APPLICATION

This application claims priority from U.S. Provisional Application Ser. No. 61/654,538, filed on Jun. 1, 2012, entitled “LIGHT-EMITTING ASSEMBLY AND LIGHT-EMITTING FLOOR SYSTEM CONTAINING THE SAME,” the entirety of which is incorporated herein by this reference.

### BACKGROUND OF THE INVENTION

1. Field

The present invention relates generally to the electrical arts. More particularly, the invention relates to a light emitting assembly and a light-emitting floor system containing same.

2. Discussion of the Related Art

Viewers of musical concerts and other theatrical performances have come to expect more and more of the visual component accompanying the audio experience. Consequently, there is a need to enhance a concertgoer's sensations by mounting lighting assemblies to provide visual displays on floors, walls and ceilings.

It is a significant drawback of conventional light-emitting assemblies, in particular, light emitting assemblies used as stage floors, that the lighting elements must be protected from the performers at the expense of the visual experience. For example, in many conventional light-emitting assemblies, the lighting element must be recessed from surface, thus greatly diminishing the effectiveness of the lighting element. Consequently, it is a desideratum for lighting assemblies in which the lighting element is flush with the surface. Moreover, many conventional light-emitting assemblies must be covered with a protective surface, such as a transparent plastic surface. This is a drawback to stage designers and lighting technicians who prefer the black or other dark colored surface that is possible with a plywood or fiber board surface. More importantly, plastic surfaces are inherently slippery lacking the traction provided by plywood or fiberboard surfaces which can be of great importance to a performer. Consequently, it is also a desideratum for light-emitting assemblies that do not require a protective surface.

### SUMMARY OF THE INVENTION

The aforementioned needs are satisfied by the light-emitting assembly in accordance with the invention. In some aspects, the light-emitting assembly is a flooring panel, a ceiling panel or a wall panel. And in some aspects, the light emitting assembly is part of a light-emitting floor system.

In one aspect, the light-emitting assembly includes a panel having a first side and an opposing second side with a plurality of bores extending from the first side to the second side and an LED light source comprising a circuit board, such as a printed circuit board and, in some aspects, a flexible printed circuit board, having a first side and an opposing second side, where the first side of the circuit board is adjacent to the second side of the panel. The LED light source further includes a plurality of LEDs and a plurality of optical wave guides, each wave guide having a first end and a second end, the first end disposed in one of the bores and the second end optically connected to one of the LEDs.

In some embodiments, the panel is a plywood panel, a fiber board panel, a plastic panel or a concrete panel. In some embodiments, the first side and the second side of the panel are parallel to one another and, in some embodiments, the first side and the second side of the panel incline toward one another. In some embodiments, the panel has a thickness of from about ½″ to about 1″ and, in some embodiments, a thickness of about ¾″.

In some embodiments, the bores have a diameter of from about 1 mm to about 12 mm and, in some embodiments, a diameter of from about 2 mm to about 6 mm. In some embodiments, the bores are arranged in a matrix with a distance of from about ¼″ to about ¾′ between the bores in each matrix column and from about ¼″ to about ¾′ between the bores in each matrix row.

In some embodiments, at least one LED provides a single color and, in some embodiments, at least one LED provides three colors.

In some embodiments, the first end of at least one optical wave guide is flush with the first side of the panel. In some embodiments, at least one optical wave guide comprises a cylinder having a length substantially the same as the length of a bore and press fit into a bore. And in some embodiments, the optical waveguides vary in length.

In some embodiments, at least one optical wave guide comprises an outwardly flaring portion extending beyond the second side of the panel and the end of the outwardly flaring portion contains a recess dimensioned to optically couple one of the LEDs. In some embodiments, the LEDs, the optical wave guides, and the bores are all aligned on an axis that is orthogonal to the first side and the second side of the panel.

In some embodiments, the light-emitting assembly further comprising a frame supporting the panel and the printed circuit board.

In another aspect, a light-emitting floor system includes a sub-floor panel and a plurality of adjoining light-emitting assemblies in accordance with the invention. In some embodiments, each panel is square or rectangular and the lengths of the sides of adjoining panels are the same. In some embodiments, the adjoining light emitting assemblies are removably secured to the surface of the sub-flooring panel.

### BRIEF DESCRIPTION OF THE DRAWINGS

FIG. 1 is a perspective view, partially cut away, of a light emitting floor system in accordance with the invention;

FIG. 2 is a perspective, exploded view of a light emitting assembly as shown in FIG. 1;

FIGS. 3A-C are perspective views of three embodiments of optical wave guides for use in the light emitting assemblies in accordance with the invention;

FIGS. 4A and B are cut-away plan views illustrating a portion of two embodiments of light emitting assemblies in accordance with the invention;

FIG. 5 is a cut-away plan view of another embodiment of a light emitting assembly in accordance with the invention; and

FIG. 6 A-C side plan views of three embodiments of LED/optical wave guide combinations for use in the light emitting assemblies in accordance with the invention.

### DETAILED DESCRIPTION OF THE PREFERRED EMBODIMENTS

Particular embodiments of the invention are described below in detail for the purpose of illustrating its principles and operation. However, various modifications may be made and the scope of the invention is not limited to the exemplary embodiments described below.

In some aspects, the light-emitting assemblies can be used as floor panels covering an underlying floor or sub-floor, as ceiling panels or as wall panels, including as panels covering an underlying wall, as free standing panels to create partition walls or simply as decorative panels hung on an existing wall. The light emitting assemblies can be used singly or can be interconnected. In some aspects, the light emitting assembly is a light-emitting floor panel, suitable for assembly with similar light emitting assemblies having sides with the same dimensions into a light-emitting portable floor that may be subsequently dismantled for reassembly on subsequent occasions at the same or another location.

In some aspects, the light emitting assembly is generally square or rectangular and, in some embodiments, each light-emitting assembly has a square shape with sides of two feet in length. The light-emitting assemblies, however, can be of any desired shape and size. The light-emitting assemblies can be secured to an underlying surface by any suitable means and in some aspects are releasably secured to the underlying surface.

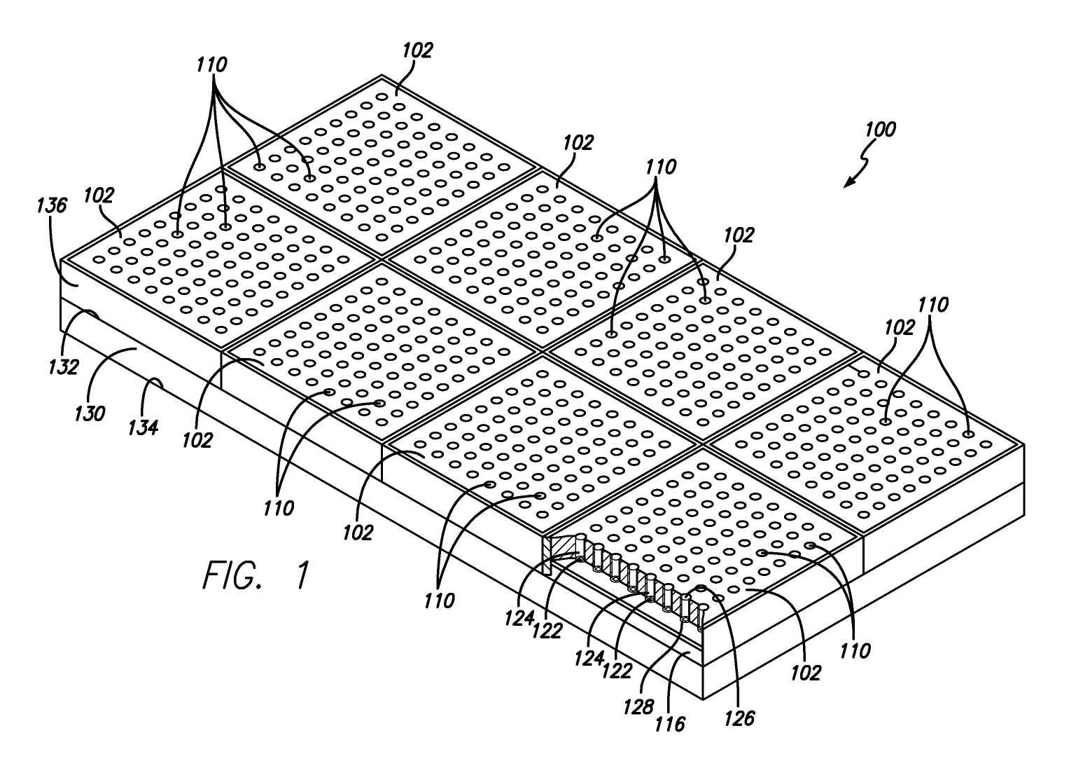

Referring to FIG. 1, there is shown a light emitting floor system 100 formed of eight adjoining light-emitting assemblies 102. It can be appreciated, however, that one or more light-emitting assemblies can be employed depending on desired size of the final light-emitting surface.

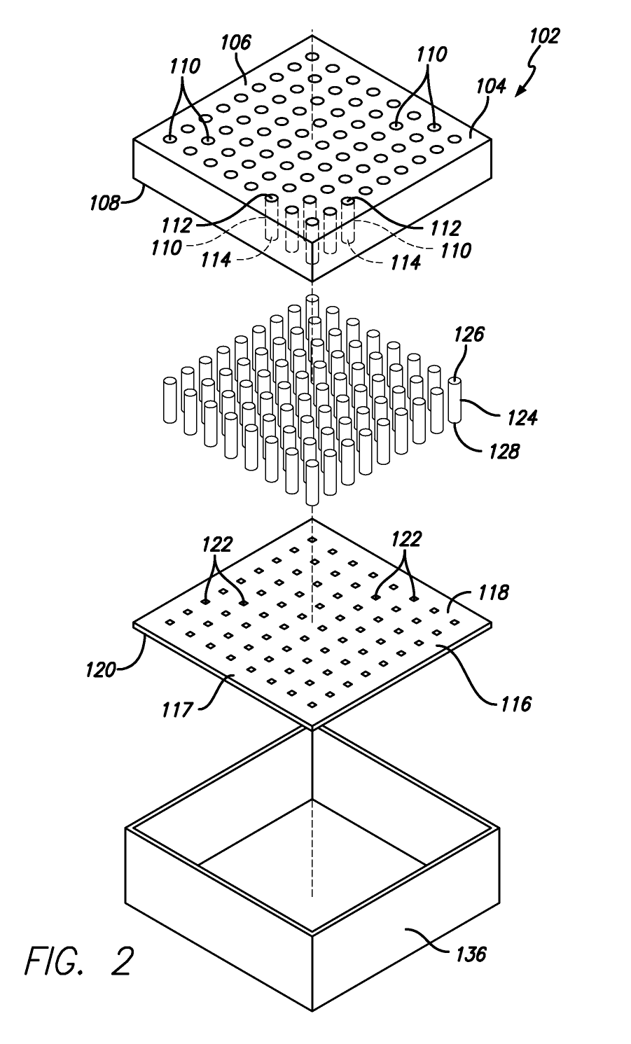

Referring additionally to FIG. 2, each light emitting assembly includes a panel 104 having a first side 106 and an opposing second side 108. In the embodiment shown in FIG. 1, the first side is substantially parallel to the second side. In alternative embodiments, the first side and the second side are inclined towards one another. The panel can be made of any suitable material such as an engineered wood, including plywood, oriented strand board, fiberboard and the like. Additional suitable materials include plastic, concrete and the like. Typically, the panel has a thickness of from about ½″ to about 1″ and in some embodiments about ¼″.

A plurality of bores 110 for emitting light through the panel 104 extend from the panel's first side 106 to its second side 108. Each bore has a first end 112 and a second end 114.

In some aspects, the bores 110 have a diameter of from about 1 mm to about 12 mm and in some aspects, the bores have a diameter of from about 2 mm to about 6 mm. As illustrated in FIGS. 1 and 2, the bores can be regularly spaced. In some aspects, the bores are arranged in a matrix with a distance of from about ¼″ to about ¼″ and, in some embodiments, about ½″ between the bores in each matrix column and a distance of from about ¼″ to about ¼′ and, in some embodiments, about ½″ between the bores in each matrix row. In other aspects, the bores are irregularly spaced or are spaced to provide a specific configuration. In those embodiments, where the panel is an engineered wood panel, such as a fiberboard panel, the bores can be formed using a CNC router.

Any suitable LED light source can be used, including circuit boards and individual LED pixels connected with wires. In the representative embodiment shown in FIG. 2, a light source 116 includes a circuit board 117 having a first side 118 and an opposing second side 120 disposed adjacent to the second side 108 of the panel 102. The circuit board is preferably a printed circuit board and, in some embodiments, a flexible printed circuit board having a plurality of electrical contacts thereon. The electrical contacts are connected to a controller (not shown).

A plurality of LEDs 122 is provided on the first side 118 of the printed circuit board 117. The LEDs can be, for example, conventional LEDs, organic LEDs (OLEDs) or polymer LEDs (PLEDs). One end of each of the electrical contacts is also coupled with an LED 122. The LEDs may be soldered in a conventional manner or may be the more compact surface mounted type. Thus, each LED is electrically coupled with a controller. Each LED is also coupled with a power source.

The LEDs 122 may provide a single color, for example red, to provide a monochrome display. Alternatively, an LED matrix may be made up of three different colors, for example, red, green and blue, of LED. Alternatively, tricolor LEDs, which are single LEDs able to display three different colors, for example, red, green and blue, may be used. With either of these latter two arrangements it is possible to provide a full color display.

In the embodiment shown in FIGS. 1 and 2, an optical wave guide 124 is disposed in each bore 110. The optical wave guide can be made out of any suitable material and can be either rigid or flexible. In some aspects the optical wave guide is an optical fiber.

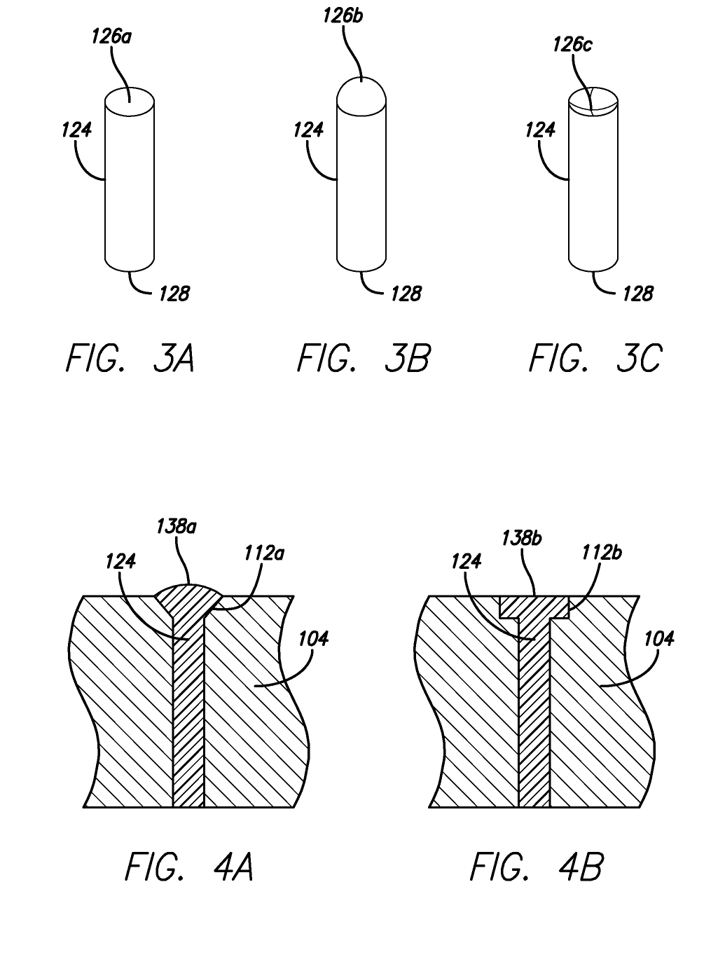

Each optical wave guide has a first, free end 126 and a second end 128 optically connected to one of the LEDs 122. In the embodiment shown in FIGS. 1 and 2, the optical wave guide has a cylindrical shape with a length substantially the same as the length of the bore and a diameter such that the optical wave guide can be press fit in the bore. In some embodiments, the optical waveguides vary in length. In the embodiments, shown in FIGS. 3A-C, the first end 126a can be planar (FIG. 3A), the first end 126b can be convex (FIG. 3B) or the first end can be concave (FIG. 3C.)

In the embodiment shown in FIG. 1, the first end 126 of the optical wave guide 124 has a diameter that is substantially the same as the diameter of the bore 110. In other embodiments, the first end contains an enlarged diameter. In the representative embodiment shown in FIG. 4A, the first end 112a of the bore flares outwardly. The first end 138a of the optical wave guide 124 contains a complementary flared portion which fits in the flare of the bore and a hemispherical portion which extends above the first side. In the representative embodiment shown in FIG. 4B, the optical wave guide ends in a flange portion 138b which fits in complimentary recess 112b in the first end of the bore.

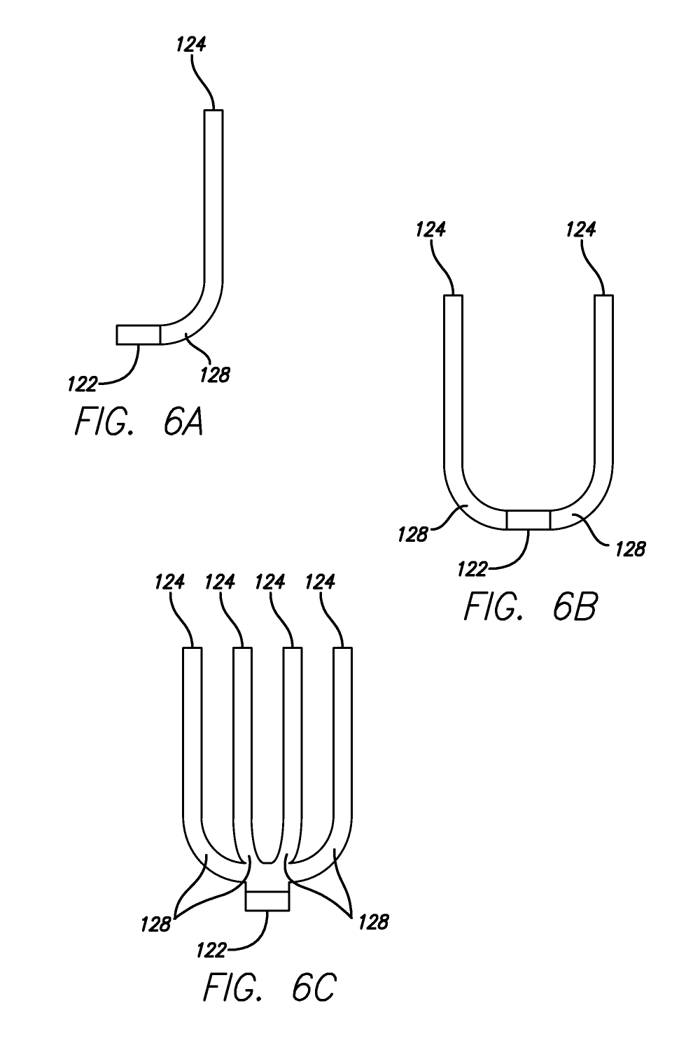

In some aspects, the second end 128 of each optical wave guide 124 is optically connected to one of the LEDs 122. In the embodiments shown in FIGS. 1, 2, 5 and 6A, the LED 122 is optically connected to single optical waveguide. 124. In the embodiments shown in FIGS. 6B and 6C, the LED is optically connected to the second end of more than one optical waveguide.

In the embodiments shown in FIGS. 1, 2 and 5, the LEDs 122, the optical wave guides 124, and the bores 110 are all aligned on an axis the is orthogonal to the first side 106 and the second side 108 of the panel 104. In the embodiments shown in FIGS. 6A-6C, the LED 122, at least a portion of the second end of the optical wave guide 124, and the bore (not shown) are aligned on different axes.

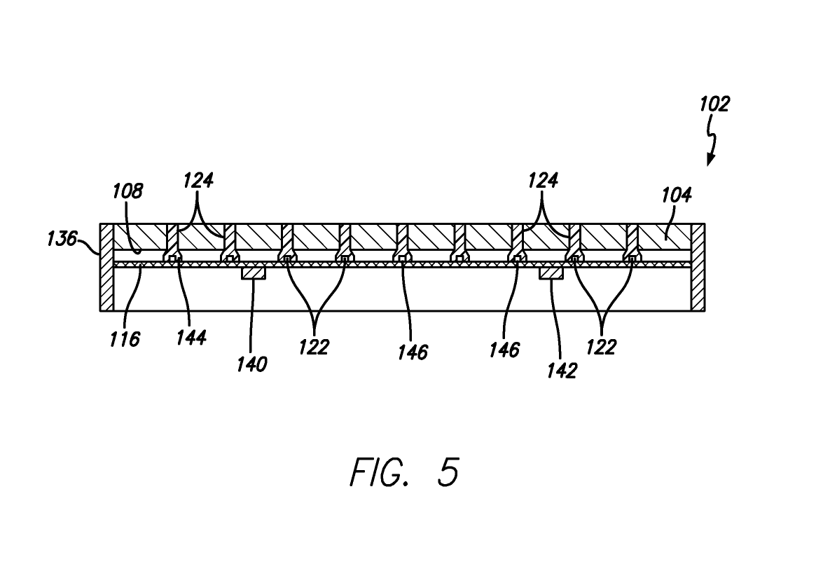

In the embodiment shown in FIG. 5, the second end of each optical wave guide 124 contains an outwardly flaring portion 144 extending beyond the second side 108 of the panel 104. The end of the outwardly flaring portion contains a recess 146 dimensioned to optically couple one of the LEDs 122.

One or more electrical additional components may be hosted on the printed circuit board 117. For example, in the embodiment shown in FIG. 5. a power connection 140 and a data connection 142 are provided on the second side 120 of the printed circuit board.

Returning to FIGS. 1 and 2, as well as 5, there are shown embodiments where the panel 104 and printed circuit board 117, in their positions adjacent one another, as well as to protect their edges. The frame is made of any suitable material including metals, such as stainless steel or aluminum.

In the embodiment illustrated in FIG. 1, there is also shown a light-emitting floor system that includes a sub-floor 130 having a top side 132 and a bottom side 134. The sub-floor is made of any suitable material, such as an engineered wood, including plywood, oriented strand board, fiberboard and the like. In the embodiment shown in FIG. 1, the sub-floor has a rectangular surface with a length of eight feet and a width of about four feet.

The eight adjoining light emitting assemblies 102 each have a square surface with a length of two feet on each side. The light emitting assemblies are secured to one another and to the top side of the sub-floor using any suitable method. Adjoining panels may be powered independently or dependently. The adjoining panels may for instance be electrically interconnected.

The adjoining panels 104 are preferably configured to emit sequenced lights. Sequenced lights include a plurality of LEDs 122 that are controlled to display varying intensity and/or color of light, including moving images. The LEDs are preferably in communication with each other and controlled by a single or a series of controllers, which coordinate the display provided. The LEDs may be connected to each other and/or the controller by any suitable means, including, but not limited to, wired or wireless connections.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

We claim:

1. A light-emitting assembly comprising:
a panel having a first side and an opposing second side;
a plurality of bores extending from the first side to the second side;
an LED light source comprising:
a circuit board having first side and an opposing second side, the first side of the circuit board adjacent to the side of the panel;
a plurality of LEDs operably connected to the first side of the circuit board; and
a plurality of optical wave guides, each wave guide having a first end and a second end, the first end disposed in one of the bores and the second end optically connected to one of the LEDs.

2. The light-emitting assembly of claim 1 wherein the circuit board is a printed circuit board.

3. The light-emitting assembly of claim 1 wherein the circuit board is a flexible printed circuit board.

4. The light-emitting assembly of claim 1 wherein the panel is a flooring panel, a ceiling panel or a wall panel

5. The light-emitting assembly of claim 1 wherein the panel is a flooring panel.

6. The light-emitting assembly of claim 5 wherein the first side and the second side of the panel are parallel to one another.

7. The light-emitting assembly of claim 5 wherein the first side and the second side of the panel incline toward one another.

8. The light-emitting assembly of claim 5 wherein the panel is a plywood panel, a fiber board panel, a plastic panel or a concrete panel.

9. The light-emitting assembly of claim 5 wherein the panel is a plywood panel or a fiber board panel.

10. The light-emitting assembly of claim 9 wherein the panel has a thickness of from about ½′ to about 1″.

11. The light-emitting assembly of claim 9 wherein the panel has a thickness of about ¼″.

12. The light-emitting assembly of claim 2 wherein the bores have a diameter of from about 1 mm to about 12 mm.

13. The light-emitting assembly of claim 1 wherein the bores have a diameter of from about 2 mm to about 6 mm.

14. The light-emitting assembly of claim 13 wherein the bores are arranged in a matrix with a distance of from about ¼″ to about ¾′ between the bores in each matrix column and from about ¼″ to about ¾′ between the bores in each matrix row.

15. The light-emitting assembly of claim 1 wherein at least one LED provides a single color.

16. The light-emitting assembly of claim 1 wherein at least one LED provides three colors.

17. The light-emitting assembly of claim 1 wherein the first end of at least one optical wave guide is flush with the first side of the panel.

18. The light-emitting assembly of claim 1 wherein at least one optical wave guide comprises a cylinder having a length substantially the same as the length of a bore and press fit into a bore.

19. The light emitting assembly of claim 1 wherein the optical waveguides vary in length.

20. The light-emitting assembly of claim 1 wherein at least one optical wave guide comprises an outwardly flaring portion extending beyond the second side of the panel and wherein the end of the outwardly flaring portion contains a recess dimensioned to optically couple one of the LEDs.

21. The light-emitting assembly of claim 6 wherein, the LED, the optical wave guide and the bore are all aligned on an axis that is orthogonal to the first side and the second side of the panel.

22. The light-emitting assembly of claim 1 further comprising a frame supporting the panel and the circuit board.

23. A light-emitting floor system comprising:
a sub-floor panel and
a plurality of adjoining light-emitting assemblies, each adjoining light emitting assembly secured to a top surface of the sub-flooring panel and each light emitting assembly comprising:
a panel having a first side and an opposing second side;
a plurality of bores extending from the first side to the second side;
an LED light source comprising:
a circuit board having first side and an opposing second side, the first side of the circuit board adjacent to the side of the panel;
a plurality of LEDs operably connected to the first side of the circuit board; and
a plurality of optical wave guides, each wave guide having a first end and a second end, the first end disposed in one of the bores and the second end optically connected to one of the LEDs.

24. The light-emitting floor system of claim 23 wherein the circuit board is a printed circuit board.

25. The light-emitting floor system of claim 23 wherein the circuit board is a flexible printed circuit board.

26. The light-emitting floor system of claim 23 wherein each panel is square or rectangular and the lengths of the sides of adjoining panels are the same.

27. The light-emitting floor system of claim 23 wherein each panel is square

26. The light-emitting floor system of claim 23 wherein at least one of the adjoining light emitting assemblies is removably secured to the top surface of the sub-flooring panel.

27. The light-emitting floor system of claim 23 wherein the first side and the second side of the panel are parallel to one another.

28. The light-emitting floor system of claim 23 wherein the first side and the second side of the panel incline toward one another.

29. The light-emitting floor system of claim 23 wherein the panel is a plywood panel, a fiber board panel, a plastic panel or a concrete panel.

30. The light-emitting floor system of claim 23 wherein the panel is a plywood panel or fiber board panel.

31. The light-emitting floor system of claim 30 wherein the panel has a thickness of from about ¼′ to about 1″

32. The light-emitting floor system of claim 30 wherein the panel has a thickness of about ¾″.

33. The light-emitting floor system of claim 23 wherein the bores have a diameter of from about 1 mm to about 12 mm.

34. The light-emitting floor system of claim 23 wherein the bores have a diameter of from about 2 mm to about 6 mm.

35. The light-emitting floor system of claim 33 wherein the bores are arranged in a matrix with a distance of from about ¼″ to about ¾′ between the bores in each matrix column and from about ¼″ to about ¾′ between the bores in each matrix row.

36. The light-emitting floor system of claim 23 wherein at least one LED provides a single color.

37. The light-emitting floor system of claim 23 wherein at least one LED provides three colors.

38. The light-emitting floor system of claim 23 wherein the first end of at least one optical wave guide is flush with the first side of the panel.

39. The light-emitting floor system of claim 23 wherein at least one optical wave guide comprises a cylinder having a length substantially the same as the length of a bore and press fit into a bore.

40. The light-emitting floor system of claim 23 wherein the optical waveguides vary in length.

41. The light-emitting floor system of claim 23 wherein at least one optical wave guide comprises an outwardly flaring portion extending beyond the second side of the panel and wherein the end of the outwardly flaring portion contains a recess dimensioned to optically couple one of the LEDs.

42. The light-emitting floor system of claim 23 wherein, the LED, the optical wave guide, and the bore are all aligned on an axis that is orthogonal to the first side and the second side of the panel.

43. The light-emitting floor system of claim 23 further comprising a frame supporting the panel and the printed circuit board.
